(19) United States
(12) Patent Application Publication
(10) Pub. No.: US 2008/0189314 A1
(43) Pub. Date: Aug. 7, 2008

(54) GENERATION OF TEMPLATE FOR REFORMATTING DATA FROM FIRST DATA FORMAT TO SECOND DATA FORMAT

(75) Inventors: Venkat A Reddy, Hyderabad (IN); Rajesh Kalyanaraman, Tamil Nadu (IN)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 11/671,101

(22) Filed: Feb. 5, 2007

(51) Int. Cl. G06F 17/30

(52) U.S. Cl. 707/102; 707/E17.005

(57) ABSTRACT

A template is generated for reformatting, or converting, data from a first data formal to a second data format, where such template generation is achieved without human interaction. Particularly, data formatted in accordance with a first data format, as well as the same data but formatted in accordance with a second data format, are received. Without human intervention, a template is generated based on the data formatted in accordance with both the first and the second data formats. The template enables subsequent reformatting of data from the first data format to the second data format, without human intervention, by, for instance, using a generic data handler.

### FIELD OF THE INVENTION

The present invention relates generally to reformatting data from a first data format to a second data format, and more particularly to generating a template that allows a generic data handler to convert data from the first data format to the second data format.

### BACKGROUND OF THE INVENTION

Data, such as business-related data, is typically stored in a number of different formats. As such, it is common to have to convert data from its existing data format to a different data format. For instance, data may have to be converted from a relatively proprietary data format to a markup-language format, such as extensible Markup Language (XML).

Existing conversion or reformatting of data from one data format to another data format is typically achieved by a developer developing a specialized data handler that converts data from the former data format to the latter data format. A disadvantage of this approach is that for each unique pair of data formats, a different specialized data handler has to be developed. Development of data handlers can be tedious, and thus costly. Because of the large number of different data formats, a correspondingly large number of specialized data handlers may have to be developed.

An improvement in this respect is to employ a generic data handler. A generic data handler is able to convert data from one data format to another data format, so long as it has access to a template that provides information as to how the former data format relates to the latter data format However, an issue arises as to how the templates themselves are developed. Within the prior art, such templates are manually constructed. As such, this approach is not a significant improvement over employing specialized data handlers, since a developer or other user still has to manually construct a template for each unique pair of data formats.

Therefore, there is a need to ameliorate one or more of the above-identified disadvantages within the prior art.

### SUMMARY OF THE INVENTION

The present invention relates to generating a template for reformatting or converting data, from a first data format to a second data format, wherein such template generation is achieved without human interaction. A computerized method of an embodiment of the invention receives data formatted in accordance with a first data format, as well as the same data but formatted in accordance with a second data format. The method generates, without human intervention, a template based on the data formatted in accordance with both the first and the second data formats. The template thus enables subsequent reformatting of data from the first data format to the second data format, without human intervention, by, for instance, using a generic data handler.

A computerized system of an embodiment of the invention includes a tangible computer-readable medium and logic. The medium is to store data formatted in accordance with a first data format and the same data formatted in accordance with a second data format. The logic is to generate, without human intervention, a template based on the data formatted in accordance with the first and the second data formats, to enable subsequent reformatting or conversion of data from the first data format to the second data format. For instance, the system may include a generic data handler to convert data from the first data format to the second data format utilizing the template.

An article of manufacture of an embodiment of the invention includes a tangible computer-readable medium, and means in the medium. The tangible computer-readable medium may be a recordable data storage medium, or another type of tangible computer-readable media. The means is for generating, without human intervention, a template based on the data formatted in accordance with the first and the second data formats, to enable subsequent reformatting or conversion of data from the first data format to the second data format.

Embodiments of the invention provide advantages over the prior art. A template can be automatically generated for converting data from a first data, format to a second data format, without, human intervention, so long as there is sample data that is formatted in accordance with each of these formats. As such, a generic data handler may be employed to convert data from the first data format to the second data format using the generated template. Because a developer or other user does not have to manually construct the template, in contradistinction with the prior art, template generation is more quickly achieved.

Other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method to generate a template to enable data conversion from a first data format to a second data format, according to a general embodiment of the invention.

FIG. 2A is a diagram showing example data formatted in accordance with a first data format, in tree form, according to an embodiment of the invention.

FIG. 2B is a diagram showing the data structure of the first data format of FIG. 2A in tree form according to an embodiment of the invention.

FIG. 3A is a diagram showing the example data of FIG. 2A formatted in accordance with a second data format, in tree form, according to an embodiment of the invention.

FIG. 3B is a diagram showing the example data of FIG. 2A formatted in accordance with the second data format of FIG. 3B in modified tree form in which the delimiters of the second data format are canonically represented, according to an embodiment of the invention.

FIG. 3C is a diagram showing the data structure of the second data format of FIG. 3B in tree form, according to an embodiment of the invention.

FIG. 4A is a diagram showing the first data format of FIG. 2B being mapped to the second data format of FIG. 3C, according to an embodiment of the invention.

FIG. 4B is an equivalent diagram to that of FIG. 4A, in which the second data format is particularly in a new modified free format, according to an embodiment of the invention.

FIG. 5 is a diagram showing the resulting template that is generated for converting data from the first data format of FIG. 2B to the second data format of FIG. 3C, resulting from the mapping of the first data format to the second data format of FIG. 4B, according to an embodiment of the invention.

FIG. 6 is a diagram of a representative system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview

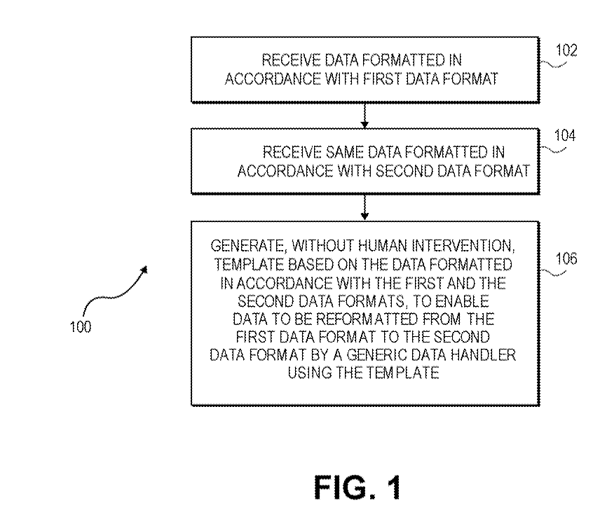

FIG. 1 shows a computerized method 100, according to a most general embodiment of the invention. Data formatted in accordance with a first data format is received (102), as is the same data formatted in accordance with a second data format (104). A template is generated, without human intervention, based on the data as formatted in accordance with the first and the second data formats (106). The template enables subsequent reformatting or conversion of data from the first data format to the second data format, such as by a generic data handler using the template.

An example of performance of the method 100 of FIG. 1 is now presented. Data formatted in accordance with a first data format is received in part 102. In one embodiment, a complete description of the first data format may be instantiated to generate complete sample data formatted in accordance with the first data format. An example of such data formatted in accordance with the first data format is as follows:

```
Employee =
    Name = Rajesh
    ID = 10
```

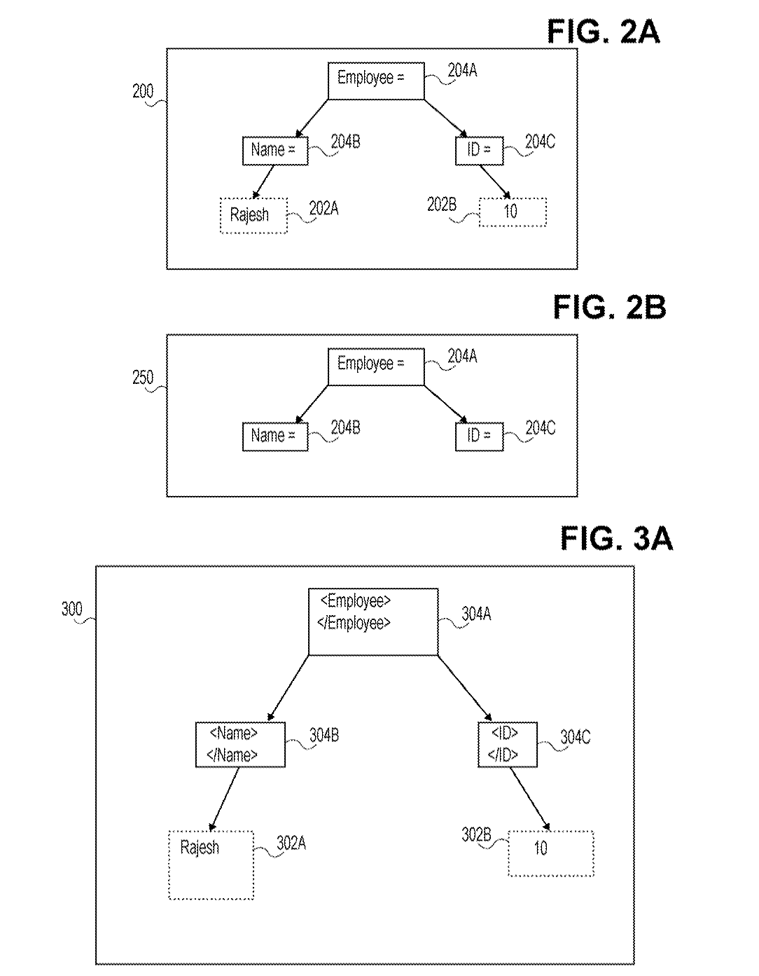

FIG. 2A shows this example data formatted in accordance with the first data format in a tree format 200, according to an embodiment of the invention. The data actually includes the data values “Rajesh” and “10” in nodes 202A and 202B, collectively referred to as the nodes 202. The other nodes 204A, 204B, and 204C, collectively referred to as the nodes 204, represent the first data, format in which this data, has been formatted. Therefore, FIG. 2B shows just the first data format in a tree format 250, according to an embodiment of the invention. The tree format 250 includes just the nodes 204, since just the nodes 204, and not the nodes 202 of FIG. 2A, represent the first data format.

The same data formatted in accordance with a second data format is also received in part 104. In one embodiment, a preexisting data handler to convert data from the first data format to the second data format may be employed in part 104 to generate the data as formatted in accordance with the second data format, from the first data format. An example of such same data formatted in accordance with the second data format is as follows:

```
<Employee>
    <Name>
      Rajesh
    </Name>
    <ID>
      10
    </ID>
</Employee>
```

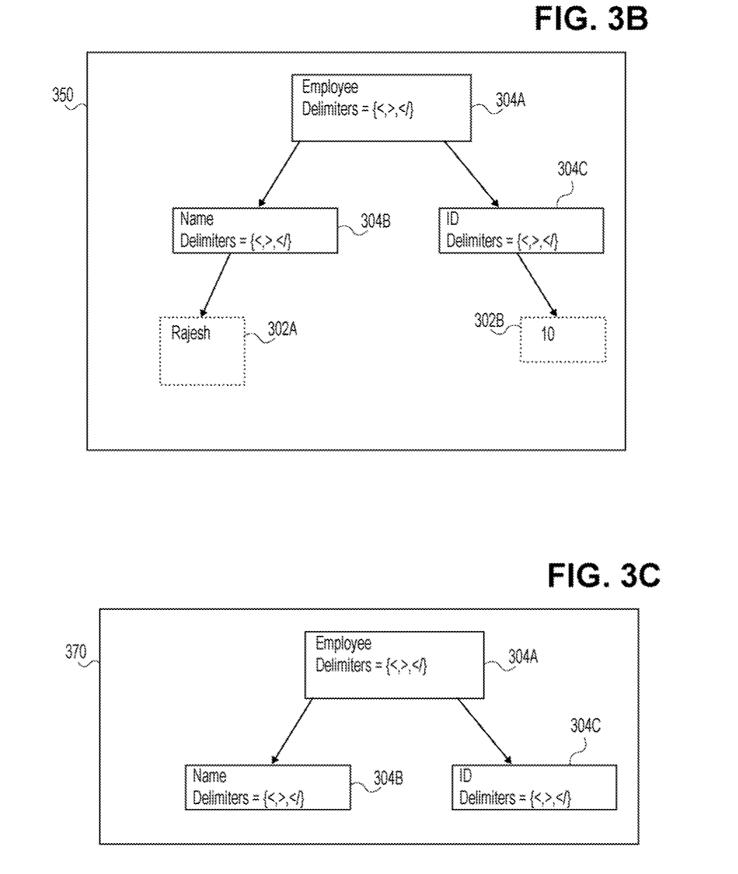

The second data format is thus specifically a markup-language format, particularly the extensible Markup Language (XML). FIG. 3A shows this example data formatted in accordance with the second data format in a tree format 300, according to an embodiment of the invention. The data actually includes the data values “Rajesh” and “10” in nodes 302A and 302B, collectively referred to as the nodes 302. The other nodes 304A, 304B, 304C, collectively referred to as the nodes 304, represent the second data format in which this data has been formatted. The characters identifying the tags <Employee>, </Employee>, <Name>, </Name>, <ID>, and </ID> are referred to as delimiters. These characters are specifically “<”, “>”, and “</”.

Thus, FIG. 3B shows the example data formatted in accordance with the second data format in a modified tree format 350 that canonically represents the delimiters, according to an embodiment of the invention. As before, the data actually includes the data values in nodes 302. The other nodes 304 represent the second data format, where the delimiters are indicated separately. FIG. 3C shows just the second data format in a tree format 370, according to an embodiment of the invention. The tree format 370 includes just the nodes 304 as in the modified tree format 350 of FIG. 3B since just the nodes 304, and not the nodes 302 of FIGS. 3A and 38, represent the second data format.

Next, without human intervention, a template is generated based on the data formatted in accordance with both the first and the second data formats, in part 106 of the method 100. Thus, the data in the first data format may he converted to a tree format, as in FIG. 2A, and the first data format retrieved as a tree data structure, as in FIG. 2B. That is, the data as formatted in accordance with the first data format may be parsed into a number of nodes. For each data value within the data, the structure of the data value within the first data format is thus determined, where the structures of all the data values correspond to the first data format in a tree data structure, as in FIG. 28. A structure of a data value includes or encompasses, for instance, one or more nodes within the tree data structure that precede the node actually containing the data value.

Similarly, the data in the second data format may be converted to a tree format, as in FIG. 3A, and then to a modified tree format depicting the delimiters, as in FIG. 38. The second data format may then be retrieved as a tree data structure, as in FIG. 3C. That is, the data as formatted in accordance with the second data format may be parsed into a number of nodes. For each data value within the data, the structure of the data value within the second data format is thus determined, where the structures of all the data values correspond to the second data format in a tree data structure, as in FIG. 3C. A structure of a data value includes or encompasses, for instance, one or more nodes within the tree data structure that precede the node actually containing the data value. Therefore, by receiving the data in both the first and the second data formats, the data formats themselves can be retrieved as tree data structures.

Thereafter, the tree data structure of the first data format of FIG. 2B is mapped to the tree data structure of the second data format of FIG. 3C (and vice-versa if desired). That is, for each structure of a data value within the first data format, the structure is mapped to the structure of this same data value within the second data format, as part of the template corresponding to conversion of the node from the first data format to the second data format. Achieving this mapping for all the data values thus ultimately constructs the template to convert data from the first data format to the second data format.

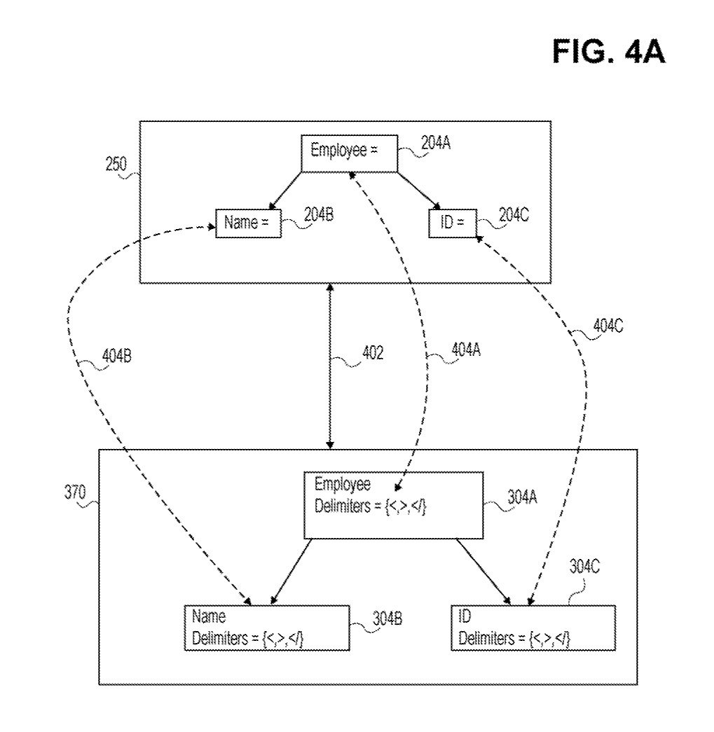

FIG. 4A shows the first data format of FIG. 28 being mapped to the second data format of FIG. 3C, according to an embodiment of the invention. The tree format 250 is particularly mapped to the modified tree format 370, as indicated by the line 402. The node 204A is mapped to the corresponding node 304A, as indicated by the line 404A, the node 204B is mapped to the corresponding node 304B, as indicated by the line 404B, and the node 204C is mapped to the corresponding node 304C, as indicated by the line 404C.

FIG. 4B shows an equivalent to FIG. 4A of the first data format of FIG. 2B being mapped to the second data format of FIG. 3C, according to an embodiment of the invention. The tree format 250 is particularly mapped to a new modified tree format 380, as indicated by the line 402. The nodes 204A, 204B, and 204C are mapped to their corresponding nodes 304A, 304B, and 304C, as before. The nodes 204 have corresponding names, or handles, to the nodes 304, particularly “Employee”, “Name”, and “ID”. Furthermore, the nodes 304A, 304B, and 304C in the tree format 380 contain a path value. The path value provides information about a node in the second data, format and its corresponding node in the first data format.

For instance, in the first data format represented by the tree format 250, the node 204A has the node name “Employee”. In the second data format represented by the modified free format 380, the corresponding node 304A indicates that this information is separated by certain delimiters within data formatted in accordance with the second data format. Furthermore, the node 304A indicates that this data is preceded by the path “Employee” within data formatted in accordance with the first data format, such as by being preceding by the path followed by an equals sign (“=”).

Likewise, in the first data format represented by the tree format 250, the node 204B has the node name “Name”. In the second data format represented by the modified tree format 380, the corresponding node 304B indicates that this information is separate by certain delimiters within data formatted in accordance with the second data format. Furthermore, the node 30413 indicates that this data is preceded by the path “Name”, where the information “Name” occurs after the information “Employee”, within data formatted in accordance with the first data format, such as by being preceded by the path “Name” followed by an equals sign (“=”), where the path “Employee” has already occurred.

More generally, for each node of the data structure of each data value, a name of the node within the first data format is determined, and a path of the node within the first data format is determined, where the path ultimately precedes the data value within the first data format. Thereafter, the data formatted in accordance with the second data format is searched for the data value, and the data formatted in accordance with the second data format is traversed to the left and/or to the right of this data value to locate the delimiters of the node within the second data format as corresponding to the path within the first data format. Storing the delimiters in the same node as the path thus constructs a node of the ultimate template for converting the first data format to the second data format. Performing this process for each node of the data structure of each data value yields the complete template.

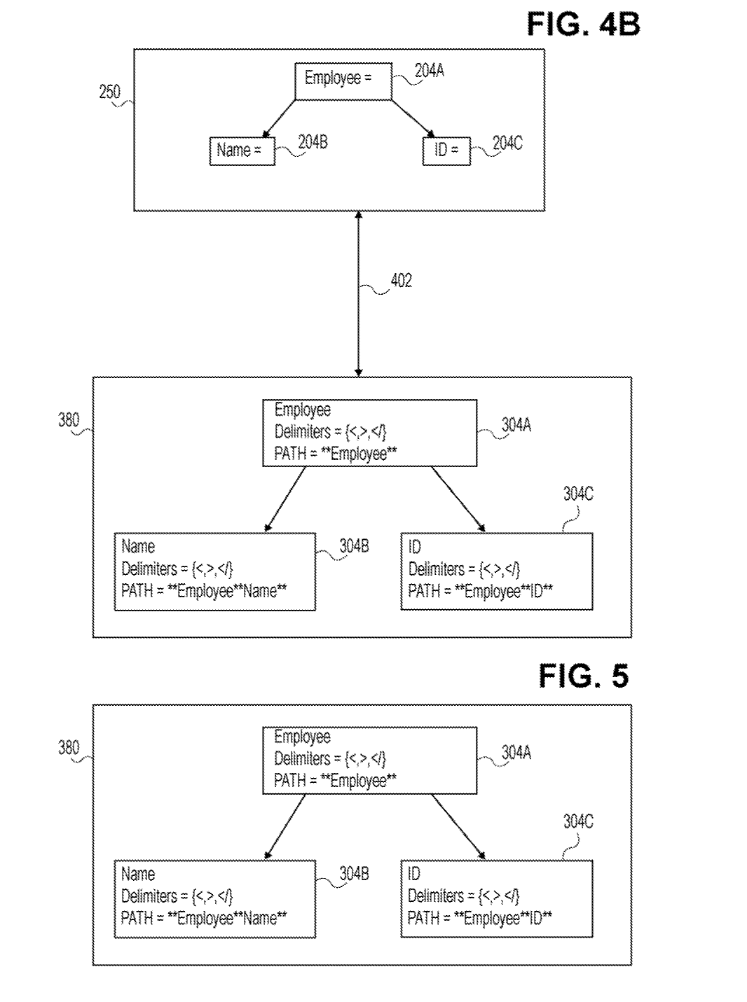

Therefore, FIG. 5 shows the resulting template that is generated for converting data from the first data format to the second data format, according to an embodiment of the invention. The template is simply the modified tree format 380 of FIG. 4B. This template contains ail the needed information to convert, data from the first data format to the second data format. As such, the template is generated by retrieving data formatted in accordance with both the first and the second data formats, representing the data in tree form for both of these data formats, acquiring the data structure of the first and the second data formats in tree form, and mapping the data structure of the first data format to that of the second data format.

What follows in the detailed description is some technical background of a system according to an embodiment of the invention. Thereafter, particular approaches by which a template to convert data from a first data format to a second data format can be generated are described. These approaches particularly provide the implementation details of the overall approach that has been described in this overview of the detailed description.

### Technical Background (System)

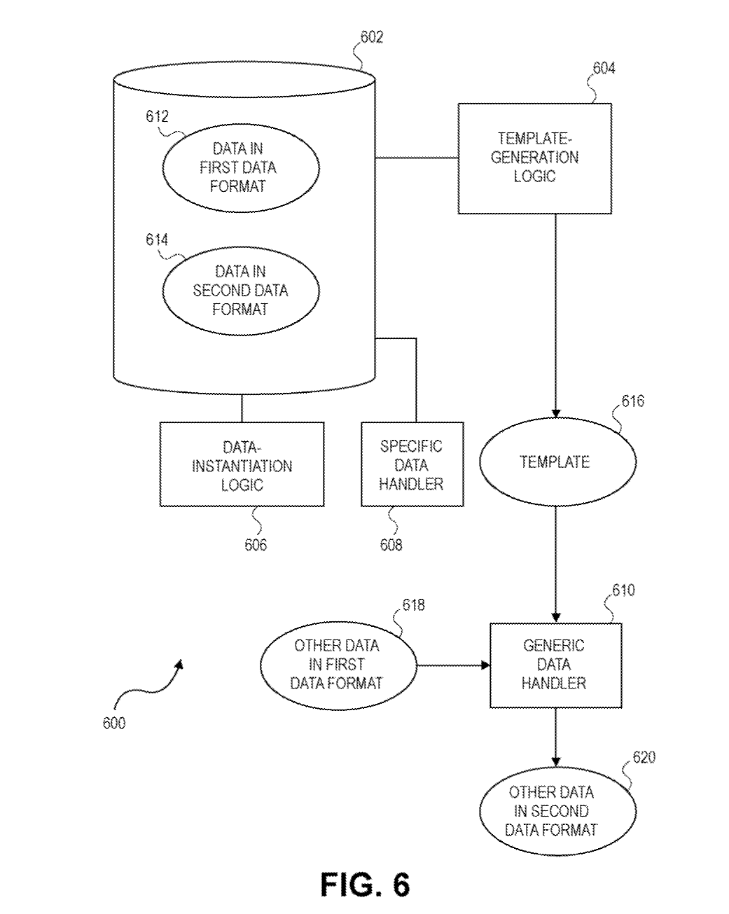

FIG. 6 shows a computerized system 600, according to an embodiment of the invention. The system 600 includes at least a computer-readable medium 602 and template-generation logic 604. The system 600 may further include data-instantiation logic 606, a specific data handler 608, and/or a generic data handler 610. Each of the logic 604, the logic 606, and the data handlers 608 and 610 may be implemented in software, hardware, or a combination of software and hardware.

The computer-readable medium 602 is a tangible computer-readable medium, like a recordable data storage medium, and stores data formatted in accordance with a first data format 612, as well as the same data formatted in accordance with a second data format 614. The template-generation logic 604 generates a template from and based on the data 612 and 614, without human intervention or human interaction, as described in the preceding section of the detailed description, and as is described in the next section of the detailed description.

Where the data formatted in accordance with the first data format 612 is not preexisting, the data-instantiation logic 606 may be used to instantiate the data 612 from a description of the first data format, as can be appreciated by those of ordinary skill within the art. The data 612 that is instantiated by the logic 606 represents full, sample data of the first data format, such that the logic 606 is advantageous in that it ensures that the first data format is completely represented within the data 612. Instantiation of data from a description of a data format is known within the art.

The specific data handler 608 can be employed in one embodiment to generate the data in the second data format 614 from the data in the first data format 612. That is, where the data formatted in accordance with the second data format 614 is not preexisting, and where the specific data handler 608 is preexisting to convert, the data from the first data format 612 to the data from the second data format 614, the data handler 608 may be employed to generate the data 614. The specific data handler 608 may be constructed as known within the prior art, by a developer, and thus with human intervention and with human interaction. The second data format 614 may further be constructed manually if the specific data handler 608 is not available or does not exist.

Once the template 616 has been generated by the template-generation logic 604, the generic data handler 610 is able to convert data formatted in accordance with the first data format 618 to data formatted in accordance with the second data format 620. Generic data handlers are known within the art, but, as has been described, the templates used to convert data from first data formats to second data formats have heretofore been manually constructed, with human intervention and human interaction. By comparison, in embodiments of the invention, such templates, like the template 616, are automatically generated without human intervention or human interaction.

Thus, the template 616 is in a form understood by the generic data handler 610. The data 618 is in the same first data format as the data 612 is, and is to be converted (as the data 620) to the same second data format as the data 614 is. The generic data handler 610 utilizes the details of the conversion from the first data format to the second data format embodied by the template 616 to convert the data 618 to the data 620. Since the template-generation logic 604 is able to construct the template 616 without human intervention or human interaction, template construction is achieved more readily than as compared to within the prior art.

### Particular Embodiment

The general approach to automatic template construction without human interaction or human intervention has been described in relation to the previous two sections of the detailed description. What is described in this section is a more specific embodiment for such template construction. Such template construction is particularly described in this section of the detailed description in more mathematically formal and algorithmic nomenclature.

In this section of the detailed description, data is defined as a function of header information, tags, data values, delimiters, and trailer information, or as f(header, tags, data values, delimiters, trailer). There are particularly three types of data. First, data may include begin and end tags, which is referred to as type one data. Second, data may be delimited data, which is referred to as type two data. For example, such data may have begin tags but no end tags for the data values. Third, data may be fixed-width data, which is referred to as type three data.

An example of type one data is as follows:

```
Header
{ Begin Tag Begin Delimiters } Begin Tag1 { Begin Tag End Delimiters }
    { Begin Tag Begin Delimiters } Begin Tag2 { Begin Tag End Delimiters }
Data Value { End Tag Begin Delimiters } End Tag2 { End Tag End Delimiters }
    { Begin Tag Begin Delimiters } Begin Tag3 { Begin Tag End Delimiters }
Data Value { End Tag Begin Delimiters } End Tag3 { End Tag End Delimiters }
    { Begin Tag Begin Delimiters } Begin Tag4 {Begin Tag End Delimiters }
      { Begin Tag Begin Delimiters } Begin Tag5 { Begin Tag End Delimiters }
Data Value { End Tag Begin Delimiters } End Tag5 { End Tag End Delimiters }
      { Begin Tag Begin Delimiters } Begin Tag6 { Begin Tag End Delimiters }
Data Value { End Tag Begin Delimiters } End Tag6 { End Tag End Delimiters }
      { End Tag Begin Delimiters } End Tag4 { End Tag End Delimiters }
.....
{ End Tag Begin Delimiters } End Tag1 { End Tag End Delimiters }
......
{ Begin Tag Begin Delimiters } Begin Tagn-1 { Begin Tag End Delimiters } Data
Value { End Tag Begin Delimiters } End Tagn-1 { End Tag End Delimiters }
{ Begin Tag Begin Delimiters } Begin Tagn { Begin Tag End Delimiters } Data
Value { End Tag Begin Delimiters } End Tagn { End Tag End Delimiters}
Trailer
```

It is noted that if is not mandatory for type one data to have some of the delimiters noted below in order to operate properly. However, the description below presumes that a data value is flanked by a tag, such as a begin tag or an end tag. Other embodiments of the invention, however, can operate on other types of type one data.

An example of type two data is as follows:

Header
{ Delimiters } Data Value
{ Delimiters } Data Value
{ Delimiters } Data Value
.....
{Delimiters} Data Value {Delimiters}
Trailer

It is noted that type two data does indeed fit into the type one data model where there are no begin tags or end tags. However, type two data is given its own category, as it is processed differently as described below.

An example of type three data is as follows:

Header DataValue DataValue DataValue DataValue Trailer

It is noted that type three data also does indeed fit into the type one data model where there are no begin tags, end tags, or delimiters to separate data values. However, type three data is given its own category, as it is also processed differently as described below. Each data value is of fixed length in type three data.

Furthermore, in this section of the detailed description, a data structure is defined as a function of header information, tags, delimiters, and trailer information, or as f(header, tags, delimiters, trailer). Thus, within a data structure there are no data values. Rather, a data structure defines the structure of data. Data is particularly an instance of a data structure that has been populated within data, values.

Header information typically comes at the beginning of data. The header information usually contains information useful for connectivity, and is not particularly of interest here. However, the header information may sometimes contain information on the specific tags and the delimiters being used. In this section of the detailed description, though, for descriptive convenience and simplicity, it is presumed that the header information does not contain such information. Likewise, trailer information typically comes at the end of data, and also usually contains information useful for connectivity, such that it is not particularly of interest here.

Tags are the symbols that give significance to the data values that follow or precede the tags. Tags indicate to a computer program how to handle these data values. Tags are usually well defined for any particular data format, such as the extensible Markup Language (XML) format, the Health Level Seven (HL7) format, the National Council for Prescription Drug Programs (NCPDP) format, and various name-value pair formats. Finally, delimiters are the symbols employed to separate the different elements of a data format. For instance, the delimiters may mark the end of a tag and the beginning of data related to the tag. Delimiters are unique in that neither the data nor the tags desirably can include the symbols employed as delimiters.

As used in the remainder of this section of the detailed description, the terms standard data, standard data format, target data, and target data format differ only because it is known a priori how to process standard data formatted in accordance with a standard data format, whereas such processing is not known as to target data formatted in accordance with a target data format. Such processing includes traversal through the data, and the ability to perform operations on the data. Such operations can include data extraction, updating, and insertion, as well as data deletion, while retaining the standard data format itself.

A path of a node within a standard data structure is defined as the XPath equivalent of a node within standard data. Thus, this path is defined as (Tagi|i=1, . . . , n} where if given Tagi, Tagj, and i=j-1, Tagi is the tag corresponding to the parent node of the node corresponding to tagj. Path containment is defined as follows, Pathi is said to be contained within Pathj if Pathi⊂Pathj. The node corresponding to Pathi contains the node corresponding to Pathj. A parent path is defined as follows. Pathi is said to be the parent path if Pathj, if Pathi⊂Pathj and there exists no other node with Pathk such that Pathi⊂Pathk⊂Pathj. The scope of a node, S, is defined as the information that is relevant to the node, where there is valid data, such that if the scope of the node is removed, the data remains valid. Left movement is defined as movement towards the left within data, whereas right movement is defined as movement to the right within data.

A set of delimiters D is defined as follows. Every data format, is built upon a predefined set of delimiters, which is represented as D. Furthermore, D is divided into four sets: {Begin Tag Begin Delimiters}, {Begin Tag End Delimiters}, {End Tag Begin Delimiters}, and {End Tag End Delimiters}. Therefore, D={Begin Tag Begin Delimiters} ∪ {Begin Tag End Delimiters} ∪ {End Tag Begin Delimiters} ∪{End Tag End Delimiters}. It is noted that the sets of delimiters {Begin Tag Begin Delimiters}, {Begin Tag End Delimiters}, {End Tag Begin Delimiters}, and {End Tag End Delimiters} for a given data format is predetermined by a user. Five axioms are now provided. Axiom one is that delimiters can be formed only from adjacent characters. For example, char[1]+char[3] cannot form a delimiter because char[2] is not present and char[1] and char[3] are not adjacent characters. Axiom two is that if delimiter deli ε one of the sets {Begin Tag Begin Delimiters}, {Begin Tag End Delimiters}, {End Tag Begin Delimiters}, and {End Tag End Delimiters}, then delim is an element of that set and is valid for all of the data. Axiom three is that a delimiter cannot include redundant characters. For example, if char[1-2] is a delimiter then char[1-3] cannot be a delimiter; likewise, char[1-4] cannot be a delimiter.

Axiom four is with respect to the precedence of delimiters within a set of delimiters. If delim1 and delim2 occur in a portion of data, and if delim1 precedes delim2, then delim1 is considered to occur within the portion of the data, and delim2 is not said to occur within this portion of the data. For example, a portion of text may be represented as char[i-j], that is, the characters between and including the i-th and j-th position within data. If within char[i-j] delim1 and delim2 occur, and delim1 precedes delim2, then delim2 is ignored. The user may define the precedence of delimiters with a given set of delimiters.

Axiom five is with respect to the precedence of delimiter sets. The precedence of delimiter sets within left movements from a data value within data is as follows: first. {Begin Tag End Delimiters}; second, {Begin Tag Begin Delimiters}; and third, {End Tag End Delimiters} and {End Tag Begin Delimiters} (the latter two sets being of equal precedence). Thus, if delim1 ε {Begin Tag End Delimiters} and delim2 ε {Begin Tag Begin Delimiters}, and delim1 and delim2 occur in a portion of text char[i-j] nearest to a data value, then delim2 is ignored.

The precedence of delimiter sets within left movements after the first delimiter has been encountered is as follows: first, {Begin Tag Begin Delimiters}; second, {End Tag Begin Delimiters}, {End Tag End Delimiters}, and {Begin Tag End Delimiters} (the latter three sets being of equal precedence). The precedence of delimiter sets within right movements from a data value within data is: first, {End Tag Begin Delimiters}; second, {End Tag End Delimiters}; and third, {Begin Tag Begin Delimiters} and {Begin Tag End Delimiters} (the latter two sets being of equal precedence). Finally, the precedence of delimiter sets within right movements after the first delimiter has been encountered is: first, {End Tag End Delimiters}; second, {Begin Tag Begin Delimiters}, {Begin Tag End Delimiters}, and {End Tag Begin Delimiters} (the latter three sets being of equal precedence).

Two lemmas follow from axiom five. First, lemma one is that in all left movements, precedence of delimiters in both {End Tag End Delimiters} and {End Tag Begin Delimiters} is equal. Second and likewise, lemma two is that in all right movements, precedence of delimiters in both {Begin Tag Begin Delimiters} and {Begin Tag End Delimiters} is equal. Furthermore, a provable theorem is that if char[i-j] contains a set of delimiters and char [(i-1)-j] contains the same set of delimiters, then char [(i-2)-j] also contains the same set of delimiters if char[(i-2)] is not a delimiter.

Two fetching algorithms, to fetch the first delimiter from a position POS within data, are defined as follows in pseudo-code understandable by those of ordinary skill within the art. The first fetching algorithm is for left movement:

```
FetchFirstDelimForLeftMovement(Position POS)
{
  K = POS−1;
  S1 be the set of delimiters initialized to null;
  From (i=POS−1;i>Begin Of File; i−−)
  {
    Fetch all delimiters in char[i−K]; (This can be done by checking
whether each delimiter exists in char[i−K])
    If(there are no delimiters in char[i−K])
    {
      continue;
    }
    else
    {
      If(there is no difference in delimiters in
      char[i−K] and char[(i−1)−K]) //
Using Theorem One
      {
        Initialize S1 to the set of delimiters in char[i−K];
        break;
      }
      else
      {
        continue;
      }
    }
  }
  Based on precedence of sets, order delimiters in S1 (by Axiom Four and
Axiom Five)
  Select the highest precedent delimiter.
  Return the delimiter.
}
```

The second fetching algorithm is for right movement:

```
FetchFirstDelimForRightMovement(Position POS)
{
  K = POS+1;
  S1 be the set of delimiters initialized to null;
  From (i=POS+1;i<End Of File; i++)
  {
    Fetch all delimiters in char[i−K];
    If(there are no delimiters in char[i−K])
    {
    continue;
    }
    else
    {
      If(there is no difference in delimiters in
      char[i−K] and char[(i+1)−K]) //
Using Theorem One
      {
        Initialize S1 to the set of delimiters in char[i−K];
        break;
      }
      else
      {
        continue;
      }
    }
  }
  Based on precedence of sets, order delimiters in S1 (by Axiom Four and
Axiom Five)
  Select the highest precedent delimiter.
  Return the delimiter.
}
```

What is described next is automatic template generation, without human interaction or invention, for data to be converted from a first data format to a second data format, where the first and the second data formats are both type one data formats, are both type two data formats, or where one is a type one data format and the other is a type two data format. As will be able to be appreciated by those of ordinary skill within the art, the algorithm is slightly varied for type three data. In particular, markers, as defined below, are created, but the length of the data value is indicated within the template. This indication can be achieved automatically or manually. Another approach for type three data is to determine whether any delimiters exist within the proximity of a data value. If none do, then the data in question is type three data.

A marker is meta data, tags, or another types of special characters employed to mark the scope of a tag and other information related to the tag. Such other information may include path information, for instance. The other information may further include other values, such as constraints on the data values contained within a tag. Optionally and cardinality may further be contained within a marker.

For the algorithm, standard data structures may be received, instantiated, and passed to existing data handlers to retrieve the corresponding target data. While instantiating the standard data structures, it is ensured that each node value is unique. One instance is instantiated for an N cardinality node. All optional nodes are further instantiated within the standard data. Thereafter, given standard data and its corresponding target data, the standard data is traversed through, and the leaf node data values are retrieved. The target data is then searched for corresponding data values. Once all the data values are located within the target data, the target data is traversed to the left and to the right to define the scope of the node in question.

In one embodiment, while the target data (i.e., the data formatted in accordance with the second data format, to use the nomenclature in the previous sections of the detailed description) is being traversed for a given data value, a table is constructed to store meta information regarding conversion of the standard data (i.e., the formatted in accordance with the first data format) to the target data. The table may include such information as the name of the node within the standard data format, the path within the standard data format, and the begin tag begin delimiter position within the target data format. The table may further include such information as the begin tag end delimiter position within the target data format, the end tag begin delimiter position within the target data format, and the end tag end delimiter position within the target data format.

Pseudo-code understandable by those of ordinary skill within the art for the algorithm is now presented in two sections, where each section is presented after one or more summarizing sentences. In the following first section, the algorithm is defined via the function main( ), where standard data has been already converted to target data, and the target data has a given type. In particular, the table that has been described is constructed, via a recursive function createNodeStructure( ). It is noted that the table itself is the template for converting data of the standard data type to the target data type in this embodiment. In addition, the createNodeStructure( ) function, or method, is that which parses the nodes within the data sample provided, such as the nodes 204B and 204C in FIG. 2A, until a leaf node is encountered, such as the leaf nodes 202A and 202B in FIG. 2A.

```
public main(Standard Data, Target Data, Target Data Mime Type)
{
  1. Create a new Table TABLE
  2. TABLE = createNodeStructure(Standard Data Root Node, TABLE);
}
public Table createNodeStructure(Node NODE, Table TABLE)
{
  For each Element in NODE
  {
    Path = path of the Element in the Standard Data.
    if(Element is Leaf Node)
    {
      1. ROW = createLeafNodeStructure(Element);
      2. Add ROW to TABLE.
    }
    else
    {
      1. TABLE1 = createNodeStructure(Element, TABLE);
      2. Create a new row, say ROW1.
      3. Search the delimiter with the least positional value, among
rows in TABLE1 with Path contained within the Paths column, in
TABLE1. Say the least positional value is denoted by POS.
Before POS search for first delimiter, say
delim. delim ∈ D using FetchFirstDelimForLeftMovement( ).
        If (delim ∈ {Begin Tag End Delimiters} )
        {
          1. Populate the position of delim in the Begin Tag End
delimiter position column.
          2. Search for the first occurrence of any delim1 ∈ D before
the position of delim using FetchFirstDelimForLeftMovement( ).
            If (delim1 ∈ {Begin Tag Begin Delimiters} )
            {
              1. Populate position of delim1, for ROW1, in the
Begin Tag Begin Delimiter position column.
              2. Create a Marker before delim1 in the Target Data.
            }
            else If (delim1 ∈ {End Tag End Delimiters} ∪ {End Tag
Begin Delimiters} ∪ {Begin Tag End Delimiters})
            {
              1. Populate position of delim1 in the Other positional
values column.
              2. Create a Marker after delim1 in the Target Data.
            }
            else Throw Error
        }
        else If (delim ∈ {Begin Tag Begin Delimiters} )
        {
            1. Populate position of delim in the Begin Tag Begin
Delimiter position column.
            2. Create a Marker before delim in the Target Data.
        }
        else If (delim ∈ {End Tag End Delimiters} ∪ {End Tag Begin
Delimiters})
        {
            1. Populate position of delim in the Other positional
values column.
            2. Create a Marker after delim in the Target Data.
        }
        else Throw Error
      4. Search the delimiter with the max positional value, among
rows in TABLE1 with Path contained within the Paths column, in
TABLE1. Say the same is denoted by POS1. After POS1
search for first delimiter, say delim2. delim2 ∈
using FetchFirstDelimForRightMovement( ).
        If (delim2 ∈ {End Tag Begin Delimiters} )
        {
          1. Also populate the position of delim2 in the End Tag Begin
Delimiter position column.
          2. Search for the first occurrence of any delimiter, say delim3
∈ D after the position of delim2 using
FetchFirstDelimForRightMovement( ).
          If (delim3 ∈ {End Tag End Delimiters} )
          {
            1. Populate position of delim3, for ROW1, in the End Tag
End delimiter position column.
            2. Create a Marker after delim3 in the Target Data.
          }
          else If (delim3 ∈ {Begin Tag Begin Delimiters} ∈ {Begin
Tag End Delimiter} ∈ {End Tag Begin Delimiters})
          {
            1. Populate position of delim3 in the Other positional
values column.
            2. Create a Marker before delim3 in the Target Data.
          }
          else Throw Error
        }
        else If (delim2 ∈ {End Tag End Delimiters} )
        {
          1. Populate position of delim2 in the End Tag End delimiter
position column.
          2. Create a Marker after delim2 in the Target Data.
        }
        else If (delim2 ∈ {Begin Tag Begin Delimiters} ∪ {Begin Tag
End Delimiters} )
        {
          1. Populate position of delim2 in the Other positional values
column.
          2. Create a Marker before delim2 in the Target Data.
        }
        else Throw Error
      5. Add ROW1 to TABLE1.
    }
      6. Add TABLE1 to TABLE
  }
  return TABLE;
}
```

The following section of the pseudo-code for the algorithm defines a function createLeafNodeStructure( ). This function, or method, is called within the previous section of the pseudo-code to parse the leaf nodes within the data sample provide, such as the leaf nodes 202A and 202B in FIG. 2A.

```
public Row createLeafNodeStructure(LeafNode LEAF)
{
  1. Fetch the Data Value for the Leaf Node LEAF in Standard Data.
  2. Find the Occurrence of it in Target Data. If Data Value found, mark
the same. Else raise an Error and terminate program.
  3. Create a row, ROW, of the table that has been described.
  4. Populate the Path of the Leaf Node, in the Standard Data, in Path
Value of Standard Data Tag column, for ROW.
  5. Search for first occurrence of any of the delimiter before Data
Value, say delim, from the list of Delimiters D before the Data Value
using FetchFirstDelimForLeftMovement( ).
    If (delim ∈ {Begin Tag End Delimiters} )
    {
      1. Populate the position in the Begin Tag End delimiter position
column with position of delim.
      2. Search for the first occurrence of any delim1 ∈ D before the
position of delim using FetchFirstDelimForLeftMovement( ).
        If (delim1 ∈ {Begin Tag Begin Delimiters} )
        {
          1. Populate position of delim1 in column Begin Tag Begin
Delimiter position.
          2. Create a Marker before delim1 in the Target Data.
        }
        else If (delim1 ∈ {End Tag End Delimiters} ∪ {End Tag Begin
Delimiters} ∪ {Begin Tag End Delimiters})
        {
          1. Populate the position of delim1 in column Other positional
values.
          2. Create a Marker after delim1 in the Target Data.
        }
        else Throw Error
    }
    else If (delim ∈ {Begin Tag Begin Delimiters} )
    {
      1. Populate the position of delim in column Begin Tag Begin
Delimiter position.
      2. Create a Marker before delim in the Target Data.
    }
    else If (delim ∈ {End Tag End Delimiters} ∪ {End Tag Begin
Delimiters} )
    {
      1. Populate the position of delim in column Other positional
      values.
      2. Create a Marker after delim in the Target Data.
    }
    else Throw Error
  6. Search for first occurrence of any of the delimiter after Data Value,
say delim2, from the list of Delimiters D after the Data Value using
FetchFirstDelimForRightMovement( ).
    If (delim2 ∈ {End Tag Begin Delimiters} )
    {
      1. Also populate the position of delim2 in the End Tag Begin
Delimiter position column.
      2. Search for the first occurrence of any delimiter, say delim3 ∈ D
after the position of delim2 using FetchFirstDelimForRightMovement( ).
        If (delim3 ∈ {End Tag End Delimiters} )
        {
          1. Populate position of delim3 in column End Tag End
delimiter position.
          2. Create a Marker after delim3 in the Target Data.
        }
        else If (delim3 ∈ {Begin Tag Begin Delimiters} ∪ {Begin Tag
End Delimiters} ∪ {End Tag Begin Delimiters})
        {
          1. Populate the position of delim 3 in column Other positional
values
          2. Create a Marker before delim3 in the Target Data.
        }
        else Throw Error
    }
    else If (delim2 ∈ {End Tag End Delimiters} )
    {
      1. Populate the position of delim2 in column End Tag End
delimiter position.
      2. Create a Marker after delim2 in the Target Data.
    }
    else If (delim2 ∈ {Begin Tag Begin Delimiters} ∪ {Begin Tag End
Delimiters})
    {
      1. Populate the position of delim2 in column Other positional
      values.
      2. Create a Marker before delim2 in the Target Data.
    }
    else Throw Error
  7. Replace the Data Value in Target Data with the Path value of the
Leaf Node in the Standard Data.
  8. return ROW.
}
```

### Conclusion

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method for reformatting data comprising:
receiving data formatted in accordance with a first data format;
receiving the data formatted in accordance with a second data format; and,
generating without human intervention a template based on the data formatted in accordance with the first data format and the data formatted in accordance with the second data format.

2. The method of claim 1, wherein receiving the data formatted in accordance with the first data format comprises instantiating the first data format to generate complete sample data for the first data format.

3. The method of claim 1, wherein receiving the data formatted in accordance with the second data format comprises employing a preexisting data handler to convert the data from the first data format to the second data format.

4. The method of claim 1, wherein generating the template comprises parsing the data formatted in accordance with the first data format into a plurality of nodes.

5. The method of claim 4, wherein generating the template for each node having a data value further comprises:
determining a structure, of the data, value within the first data format, the structure encompassing one or more nodes;
determining a structure of the data value within the second data format, the structure encompassing one or more nodes; and,
mapping the structure of the data value within the first data format to the structure of the data value within the second data format as part of the template corresponding to format conversion of the node.

6. The method of claim 5, wherein generating the template further comprises, for each node of a structure of each data value,
determining a handle of the node within the first data format; and,
determining a path of the node within the first data format, the path ultimately preceding the data value within the first data format.

7. The method of claim 6, wherein generating the template further comprises, for each node of a structure of each data value,
searching the data formatted in accordance with the second data format for the data value; and,
traversing the data formatted in accordance with the second data format to left and to right of the data value located therein for a plurality of delimiters of the node within the second data format corresponding to the path within the first data format.

8. The method of claim 7, wherein traversing the data formatted in accordance with the second data format for the data value comprises:
constructing a table storing meta information regarding conversion of the first data format to the second data format.

9. The method of claim 8, wherein at least one of the first and the second data formats comprises a data format in which data values are each delimited by a beam tag and an end tag.

10. The method of claim 1, wherein at least one of the first and the second data formats comprises a data format in which data values are each delimited with a begin tag and no end tag.

11. The method of claim 1, wherein at least one of the first and the second data formats comprises a data format in which data values each have a fixed width.

12. A data processing system comprising:
a tangible computer-readable medium to store data formatted in accordance with a first data format and the data formatted in accordance with a second data format; and,
logic to generate without human intervention a template based on the data formatted in accordance with the first and the second data formats to enable subsequent reformatting of additional data from the first data format to the second data format without human intervention.

13. The system of claim 12, further comprising one or more of:
logic to instantiate the first data format to generate the data formatted in accordance with the first data format; and,
a preexisting data handler to specifically convert the data from the first data format to the second data format to generate the data formatted in accordance with the second data format.

14. The system of claim 12, further comprising a generic data handler to convert the additional data from the first data format to the second data format utilizing the template generated by the logic.

15. The system of claim 12, wherein the logic is to generate the template by:
parsing the data formatted in accordance with the first data format into a plurality of nodes;
for each node having a data value,
determining a structure of the data value within the first data format,
determining a structure of the data value within the second data format, and
mapping the structure of the data value within the first data format to the structure of the data value within the second data format as part of the template corresponding to format conversion of the node.

16. The system of claim 12, wherein the logic is to generate the template by:
parsing the data formatted in accordance with the first data format into a plurality of nodes;
for each node having a data value,
determining a handle of the node within the first data format,
determining a path of the node within the first data format as preceding the data value within the first data format.
searching the data formatted in accordance with the second data format for the data value, and
traversing the data formatted in accordance with the second data format to left and to right of the data value located therein for a plurality of delimiters of the node within the second data format corresponding to the path within the first data format.

17. A data processing system comprising:
a tangible computer-readable medium to store data formatted in accordance with a first data format and the data formatted in accordance with a second data format; and,
means for generating without human intervention a template based on the data formatted in accordance with the first and the second data formats to enable subsequent reformatting of additional data from the first data format to the second data format without human intervention.

18. An article of manufacture comprising:
a tangible computer-readable medium; and,
means in the medium for generating without human intervention a template based on the data formatted in accordance with the first and the second data formats to enable subsequent reformatting of additional data from the first data format to the second data format without human intervention.

19. The article of manufacture of claim 18, wherein the means is to generate the template by:
parsing the data formatted in accordance with the first data format into a plurality of nodes;
for each node having a data value,
determining a structure of the data value within the first data format,
determining a structure of the data value within the second data format, and
mapping the structure of the data value within the first data format to the structure of the data value within the second data format as part of the template corresponding to format conversion of the node.

20. The article of manufacture of claim 18, wherein the means is to generate the template by:
parsing the data formatted in accordance with the first data format into a plurality of nodes;
for each node having a data value,
determining a handle of the node within the first data format,
determining a path of the node within the first data format, as preceding the data value within the first data format,
searching the data formatted in accordance with the second data format for the data value, and
traversing the data formatted in accordance with the second data format to left and to right of the data value located therein for a plurality of delimiters of the node within the second data format corresponding to the path within the first data format.
